(19) United States
(12) Patent Application Publication
(10) Pub. No.: US 2021/0331340 A1
(43) Pub. Date: Oct. 28, 2021

(54) RAZOR DEVICE

(71) Applicant: NINGHAI ARK COMMODITY CO., LTD., Ningbo (CN)

(72) Inventor: Nenyan GUO, Ningbo (CN)

(21) Appl. No.: 17/372,213

(22) Filed: Jul. 9, 2021

(51) Int. Cl. B26B 21/52

(52) U.S. Cl. CPC B26B 21/521

(57) ABSTRACT

This disclosure provides a razor device, including a razor head assembly, a handle assembly and a locking assembly. The razor head assembly is rotatably connected to the handle assembly for adjusting an angle of the razor head assembly relative to the handle assembly. The locking assembly matches with the razor head assembly and the handle assembly, and is configured to switch the locking and unlocking between the razor head assembly and the handle assembly. The head assembly can be drove to rotate relative to the handle assembly. The razor head assembly is unlocked from the handle assembly via the locking assembly, and then driven to rotate the handle assembly to adjust the angle. After the desired angle is reached, the razor head assembly is locked to the handle assembly via the locking assembly again.

### TECHNICAL FIELD

This application relates to personal care products, and more particularly to a razor device.

### BACKGROUND

With the development of the society, hair removal has been very common in our lives. On one hand, the hair removal is to meet the needs of the beauty or appearance, on the other hand, if there is excessive hair, body toxins or sweat discharge through the skin will cause an odor.

The razor device is a commonly-used tool for hair removal, which render the hair removal convenient. However, the existing razor devices often struggle with inappropriate structural configuration. Specifically, the cutter assembly is fixed relative to the handle assembly, and in this case, the angle of the cutter assembly cannot be adjusted during the shaving process, which cannot satisfy the requirement of actual use.

### SUMMARY

An object of this application is to provide a razor device with an angle-adjustable razor head assembly to overcome the defects in the prior art.

To achieve the above object, this application provides a razor device, comprising:

a razor head assembly;

a handle assembly; and

a locking assembly;

wherein the razor head assembly is connected to the handle assembly, and is configured to be rotatable with respect to the handle assembly to adjust an angle of the razor head assembly relative to the handle assembly;

the locking assembly is matched with the razor head assembly and the handle assembly; and the locking assembly is configured to lock the razor head assembly to the handle assembly or unlock the razor head assembly from the handle assembly.

In an embodiment, the locking assembly comprises:

a first connecting part; and

a locking member;

wherein the first connecting part is arranged on the razor head assembly; a first end of the locking member extends into the handle assembly and is engaged with an inner side wall of the handle assembly; a second end of the locking member extends into the first connecting part to achieve connection between the razor head assembly and the handle assembly; the razor head assembly is rotatable around an axial direction of the locking member in relation to the handle assembly; the locking member is capable of moving along the axial direction of the locking member relative to the first connecting part and the handle assembly to engage the second end of the locking member with an inner side wall of the first connecting part or disengage the second end of the locking member from the inner side wall of the first connecting part, so as to lock the razor head assembly to the handle assembly or unlock the razor head assembly from the handle assembly.

In an embodiment, the handle assembly is provided with a first groove; and the first connecting part is provided with a second groove;

the locking assembly further comprises a first engagement part, a second engagement part and a third engagement part; the first engagement part is arranged on an outer side wall of the locking member; the second engagement part is arranged on an inner side wall of the first groove; and the third engagement part is arranged on an inner side wall of the second groove; and

the first end of the locking member extends into the first groove, and the first engagement part is engaged with the second engagement part; the second end of the locking member extends into the second groove; and the locking member is capable of moving along the axial direction of the locking member relative to the first groove and the second groove to engage the first engagement part with the third engagement part or disengage the first engagement part from the third engagement part, so as to lock the razor head assembly to the handle assembly or release the razor head assembly from the handle assembly.

In an embodiment, the locking member comprises a locking portion and a pushing portion; the locking portion and the pushing portion are connected with each other; an outer diameter of the locking portion is larger than that of the pushing portion; and the first engagement part is arranged on an outer side wall of the locking portion;

an end of the locking portion away from the pushing portion extends into the first groove; an end of the locking portion close to the pushing portion extends into the second groove; an end of the pushing portion away from the locking portion extends out of the first connecting part through a bottom wall of the second groove; and the end of the locking portion close to the pushing portion is configured to abut against the bottom wall of the second groove; and

the pushing portion is configured to drive the locking portion to move along an axial direction of the locking portion relative to the first groove and the second groove.

In an embodiment, the locking assembly further comprises an elastic component; the elastic component is accommodated in the handle assembly and elastically abuts against the locking member; and the elastic component is configured to provide the locking member with an elastic restoring force to allow the locking member to move close to a side of the first connecting part away from the handle assembly along the axial direction of the locking member.

In an embodiment, the razor device further comprises a rotating shaft; the razor head assembly is connected to the handle assembly via the rotating shaft; and the razor head assembly is configured to rotate around an axial direction of the rotating shaft relative to the handle assembly.

In an embodiment, the razor head assembly comprises a base and a blade; the base and the blade are detachably connected; and the base is connected to the handle assembly.

In an embodiment, the base comprises a blade cover and a blade base; the blade cover and the blade base are connected with each other; the blade is detachably arranged between the blade cover and the blade base; and the blade base is connected to the handle assembly.

In an embodiment, the handle assembly comprises a first handle and a second handle; one end of the first handle is connected to the razor head assembly, and the other end of the first handle is detachably connected to the second handle.

In an embodiment, an end of the first handle away from the razor head assembly is provided with a first through hole; an end of the second handle close to the first handle is provided with a second through hole; the handle assembly further comprises a fastening part; the fastening part is configured to pass through the first through hole and the second through hole to detachably connect the first handle with the second handle.

Compared to the prior art, the technical solutions of this application have the following beneficial effects.

The razor device provided herein includes a razor head assembly, a handle assembly and a locking assembly, where the razor head assembly is rotatably connected to the handle assembly for adjusting an angle of the razor head assembly relative to the handle assembly; the locking assembly is matched with the razor head assembly and the handle assembly, and is configured for achieving the locking and unlocking between the razor head assembly and the handle assembly. When the angle of the razor head assembly relative to the handle assembly needs to be adjusted, the razor head assembly is unlocked from the handle assembly via the locking assembly, and then is driven to rotate with respect to the handle assembly to adjust the angle of the razor head assembly relative to the handle assembly. When the desired angle is arrived, the razor head assembly is locked on the handle assembly to achieve the fixed connection between the razor head assembly and the handle assembly. In this way, the angle of the razor head assembly can be adjusted as required during the shaving process, effectively improving the safety and comfort of the razor device.

### BRIEF DESCRIPTION OF THE DRAWINGS

The accompanying drawings are intended to promote the understanding of the present disclosure. Presented in the drawings are some embodiments of the disclosure, which are merely illustrative and are not intended to limit the disclosure.

FIG. 1 is a structural diagram of a razor device according to an embodiment of the disclosure;

FIG. 2 is an exploded view of the razor device according to an embodiment of the disclosure from a first perspective;

FIG. 3 is an exploded view of the razor device according to an embodiment of the disclosure from a second perspective;

FIG. 4 is a partial exploded view of the razor device according to an embodiment of the disclosure from a first perspective;

FIG. 5 is a partial exploded view of the razor device according to an embodiment of the disclosure from a second perspective;

FIG. 6 is an exploded view of a razor head assembly of the razor device according to an embodiment of the disclosure from a first perspective; and

FIG. 7 is an exploded view of the razor head assembly of the razor device according to an embodiment of the disclosure from a second perspective.

In the drawings: 100, first engagement part; 200, second engagement part; 300, third engagement part; 10, razor head assembly; 11, base; 111, blade cover; 1111, second fastening hole; 1112, first clamping part; 1113, first limiting part; 112, blade base; 1121, first fastening hole; 1122, second clamping part; 1123, support component; 1124, comb; 12, blade; 121, second limiting part; 13, fastener; 20, handle assembly; 21, first connecting portion; 22, second connecting portion; 23, first groove; 24, fourth groove; 25, first handle; 251, first through hole; 26, second handle; 261, second through hole; 262, handle bar; 263, handle tail; 27, fastening part; 271, convex column; 272, elastic sheet; 28, anti-skid structure; 30, locking assembly; 31, first connecting part; 311, second groove; 312, third through hole; 313, stepped structure; 32, locking member; 321, first end of the locking member; 322, second end of the locking member; 323, third groove; 324, locking portion; 325, pushing portion; 33, elastic component; 40, rotating shaft; and 41, second connecting part.

### DETAILED DESCRIPTION OF EMBODIMENTS

The technical solutions of the present disclosure will be described in detail below with reference to the drawings and embodiments. It should be noted that the embodiments are only some embodiments of the disclosure, and are not intended to limit the disclosure. It should be understood that other embodiments obtained by those skilled in the art based on the content disclosed herein without paying any creative work shall fall within the scope of the present disclosure.

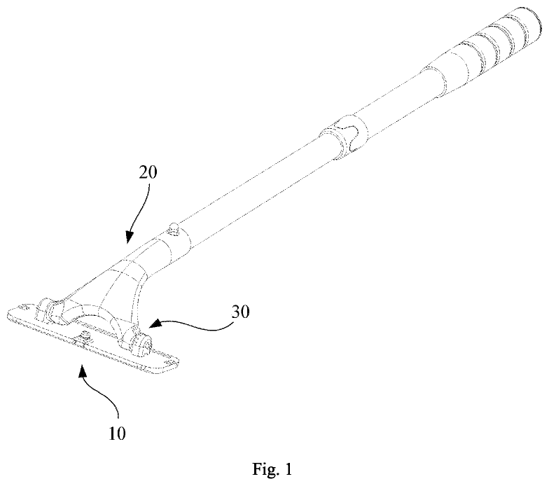

Referring to FIG. 1, an embodiment of the disclosure provides a razor device to remove hair from the surface of the human body, including a razor head assembly 10, a handle assembly 20 and a locking assembly 30. The razor head assembly 10 is connected to the handle assembly 20, and can rotate relative to the handle assembly 20 for adjusting an angle of the razor head assembly 10 relative to the handle assembly 20. The locking assembly 30 matches with the razor head assembly 10 and the handle assembly 20, and is configured to lock the razor head assembly 10 to the handle assembly 20 or unlock the razor head assembly 10 from the handle assembly 20.

When the angle of the razor head assembly 10 with respect to the handle assembly 20 needs to be adjusted, the razor head assembly 10 is first unlocked from the handle assembly 20 via the locking assembly 30, and then is driven to rotate in relation to the handle assembly 20 to adjust the angle. When the desired angle is reached, the razor head assembly 10 is locked on the handle assembly 20 to achieve the fixed connection between the razor head assembly 10 and the handle assembly 20. In this way, the angle of the head assembly 10 can be adjusted flexibly as required during the shaving process, effectively enhancing the safety and comfort of the razor device.

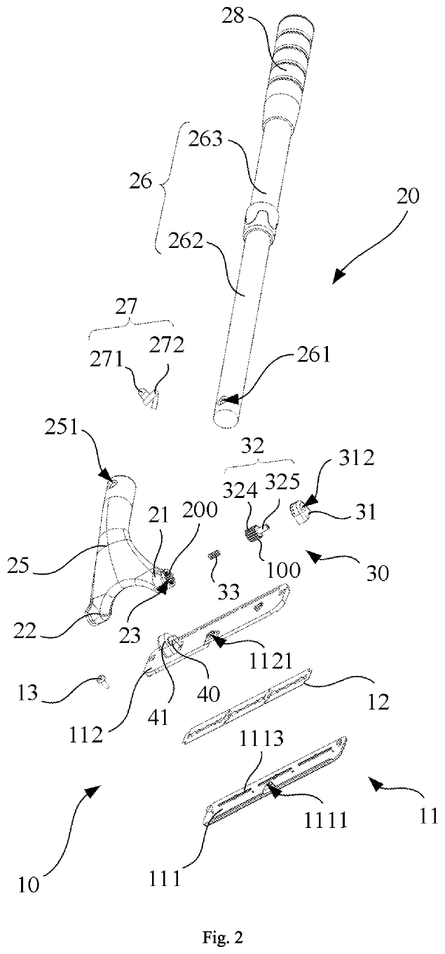

Referring to an embodiment illustrated in FIGS. 2-5, the locking assembly 30 includes a first connecting part 31 and a locking member 32. The first connecting part 31 is arranged on the razor head assembly 10. A first end 321 of the locking member 32 extends into the handle assembly 20, and is engaged with an inner side wall of the handle assembly 20. A second end 322 of the locking member 32 extends into the first connecting part 31 to connect the razor head assembly 10 to the handle assembly 20, and the head assembly 10 is rotatable around the axial direction of the locking member 32 with respect to the handle assembly 20. The locking member 32 is capable of axially moving relative to the first connecting part 31 and the handle assembly 20 to complete the engagement and disengagement between the second end 322 of the locking member 32 and an inner side wall of the first connecting part 31, so as to lock the razor head assembly 10 to the handle assembly 20 or unlock the razor head assembly 10 from the handle assembly 20.

In this embodiment, when the angle of the razor head assembly 10 relative to the handle assembly 20 needs to be adjusted, the locking member 32 is first driven to move axially in a direction away from a side of the first connecting part 31 away from the handle assembly 20 until the second end 322 of the locking member 32 is disengaged from the inner side wall of the first connecting part 31, so as to release the razor head assembly 10 from the handle assembly 20. Then the razor head assembly 10 is driven to rotate relative to the handle assembly 20 to adjust the angle of the razor head assembly 10 relative to the handle assembly 20. When the desired angle is reached, the locking member 32 is driven to move axially in a direction close to the side of the first connecting part 31 away from the handle assembly 20 until the second end 322 of the locking member 32 is engaged with the inner side wall of the first connecting part 31, and at this time, the razor head assembly 10 is locked and fixed on the handle assembly 20 again.

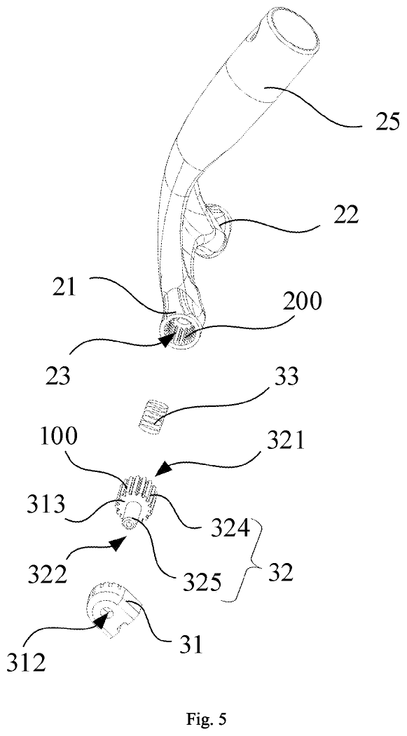

Referring to FIGS. 2 and 5, an end of the handle assembly 20 near the razor head assembly 10 is provided with a first connecting portion 21. The first end 321 of the locking member 32 extends into the first connecting portion 21, and is engaged with an inner side wall of the first connecting portion 21.

Referring to FIG. 2 and FIGS. 4-5, the handle assembly 20 is provided with a first groove 23. The first connecting part 31 is provided with a second groove 311. The locking assembly 30 further includes a first engagement part 100, a second engagement part 200 and a third engagement part 300. The first engagement part 100 is arranged on an outer side wall of the locking member 32; the second engagement part 200 is arranged on an inner side wall of the first groove 23; and the third engagement part 300 is arranged on an inner side wall of the second groove 311. The first end 321 of the locking member 32 extends into the first groove 23. The first engagement part 100 is engaged with the second engagement part 200. The second end 322 of the locking member 32 extends into the second groove 311. The locking member 32 is capable of moving axially relative to the first groove 23 and the second groove 311 to engage the first engagement part 100 with the third engagement part 300 or disengage the first engagement part 100 from the third engagement part 300, so as to lock the razor head assembly 10 to the handle assembly 20 or unlock the razor head assembly 10 from the handle assembly 20. Specifically, in this embodiment, the first groove 23 is arranged on the first connecting portion 21.

In an embodiment, the locking member 32 includes a locking portion 324 and a pushing portion 325, and the locking portion 324 and the pushing portion 325 are connected. The outer diameter of the locking portion 324 is larger than that of the pushing portion 325. The first engagement part 100 is arranged on an outer side wall of the locking portion 324. An end of the locking portion 324 away from the pushing portion 325 extends into the first groove 23, and an end of the locking portion 324 near the pushing portion 325 and the pushing portion 325 extend into the second groove 311. An end of the pushing portion 325 away from the locking portion 324 extends out of the first connecting part 31 through a bottom wall of the second groove 311, which makes it convenient to apply an external force on the end of the pushing portion 325 exposed outside the first connecting part 31 to drive the locking member 32 to move. Meanwhile, the end of the locking portion 324 near the pushing part 325 can abut against the bottom wall of the second groove 311 to limit the moving distance of the locking member 32 relative to the first groove 23 and the second groove 311. The pushing portion 325 is configured for driving the locking portion 324 to move axially relative to the first groove 23 and the second groove 311 to engage the first engagement part 100 with the third engagement part 300 or disengage the first engagement part 100 from the third engagement part 300, so as to lock the razor head assembly 10 to the handle assembly 20 or unlock the razor head assembly 10 from the handle assembly 20.

Referring to FIGS. 2-5, when the angle of the razor head assembly 10 relative to the handle assembly 20 needs to be adjusted, the pushing portion 325 is first pushed to drive the locking portion 324 to move axially in a direction away from a side of the first connecting part 31 away from the locking portion 324 until the first engagement part 100 is disengaged from the third engagement part 300, and the razor head assembly 10 is unlocked. At this time, the pushing portion 325 still partially penetrates the bottom wall of the second groove 311, and then the angle of the razor head assembly 10 relative to the handle assembly 20 is adjusted. When the desired angle is obtained, the pushing portion 325 is pushed to drive the locking portion 324 to axially move in a direction close to a side of the first connecting part 31 away from the locking portion 324 until the first engagement part 100 is engaged with the third engagement part 300 again. At this time, the razor head assembly 10 is locked on the handle assembly 20, and the end of the locking portion 324 near the pushing portion 325 abuts against the bottom wall of the second groove 311.

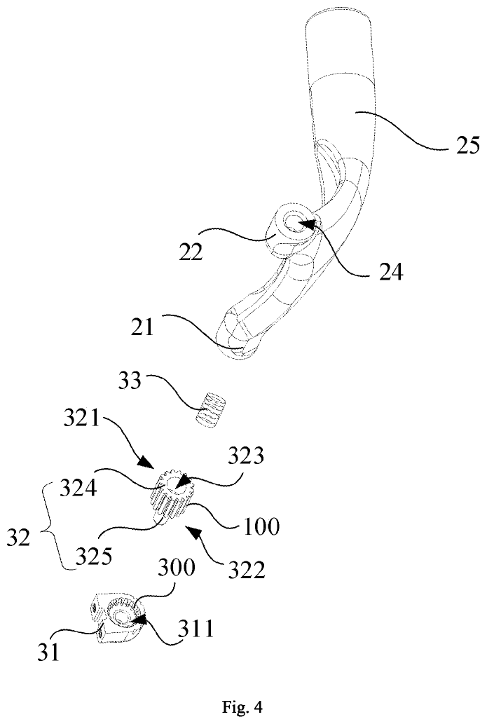

Referring to FIGS. 4-5, the first connecting part 31 is also provided with a third through hole 312. The third through-hole 312 is in communication with the second groove 311, and a stepped structure 313 is formed at the connection between the third through hole 312 and the second groove 311. An end of the pushing portion 325 away from the locking portion 324 extends out of the first connecting part 31 through the third through hole 312, and an end of the locking portion 324 near the pushing portion 325 abuts against the stepped structure 313.

In an embodiment, the first engagement part 100 includes a plurality of toothed bars, which are arranged spaced apart on an outer side wall of the locking portion 324. The second engagement part 200 includes a plurality of toothed bars, which are arranged spaced apart on an outer side wall of the first groove 23. The third engagement part 100 includes a plurality of toothed bars, which are arranged spaced apart on an outer side wall of the second groove 311. In this case, the engagement between the first engagement part 100 and the second engagement part 200, and the engagement between the first engagement part 100 and the third engagement part 300 are enhanced.

In an embodiment, the pushing portion 325 has a cylindrical structure, which facilitates the rotation of the pushing portion 325 relative to the first connecting part 31.

Referring to FIGS. 2 and 4-5, the locking assembly 30 further includes an elastic component 33. The elastic component 33 is accommodated in the handle assembly 20, and elastically abuts against the locking member 32. The elastic component 33 is configured for providing the locking member 32 with an elastic restoring force to allow the locking member 32 to move axially in a direction close to a side of the first connecting part 31 away from the handle assembly 20. During the adjustment of the angle of the razor head assembly 10 relative to the handle assembly 20, the locking member 32 is driven to move axially to compress the elastic component 33 to deform, generating the above-mentioned elastic restoring force which is opposite to the compression force applied on the elastic component 33.

When the required angle is reached, the locking member 32 is released, and moves axially under the action of the elastic restoring force in a direction close to a side of the first connecting part 31 away from the locking portion 324 until the first engagement part 100 is engaged with the third engagement part 300 again, and at this time, the razor head assembly 10 is locked on the handle assembly 20. The locking member 32 can be driven to move by the elastic restoring force of the elastic component 33, simplifying the operation.

In this embodiment, the elastic component 33 is accommodated in the first groove 23. An end of the locking member 32 near the first connecting portion 21 is provided with a third groove 323. The end of the elastic component 33 away from the first connecting portion 21 abuts against the third groove 323 to prevent the elastic component 33 from falling out of the locking member 32.

Referring to FIGS. 2-4, the razor device further includes a rotating shaft 40. The razor head assembly 10 is connected to the handle assembly 20 via the rotating shaft 40, and the razor head assembly 10 is rotatable relative to the handle assembly 20 around the axial direction of the rotating shaft 40. Specifically, the axial direction of the rotating shaft 40 is parallel to that of the locking member 32. In an embodiment, the axial direction of the rotating shaft 40 coincides with that of the locking member 32 to facilitate the rotation of the razor head assembly 10 relative to the handle assembly 20. An end of the handle assembly 20 near the razor head assembly 10 is provided with a second connecting portion 22. The first connecting portion 21 and the second connecting portion 22 are connected and arranged opposite to each other. The razor head assembly 10 is rotatably connected to the second connecting portion 22 of the handle assembly 20 via the rotating shaft 40.

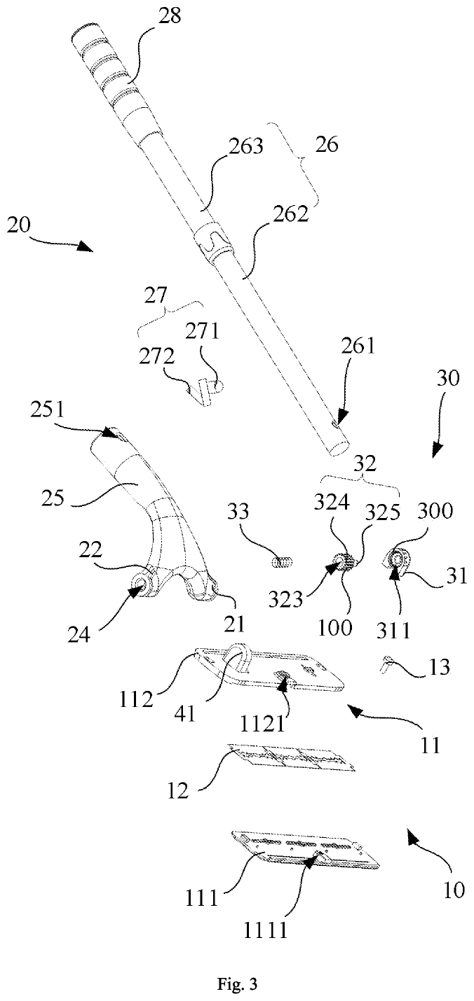

Referring to an embodiment shown in FIGS. 2-3, the razor device further includes a second connecting part 41. The second connecting part 41 is arranged on the razor head assembly 10. The second connecting part 41 and the first connecting part 31 are arranged spaced apart and opposite to each other, and the rotating shaft 40 is arranged on the second connecting part 41. Specifically, the second connecting portion 22 is provided with a fourth groove 24, and the rotating shaft 40 can extend into the fourth groove 24, and can rotatably match the fourth groove 24 to achieve the axial rotation of the razor head assembly 10 around the rotating shaft 40 relative to the handle assembly 20. In an embodiment, the outer diameter of the rotating shaft 40 is adapted to the inner diameter of the fourth groove 24 to improve the rotation stability of the rotating shaft 40 in the fourth groove 24.

In some embodiments, the matching method between the second connecting part 41 and the second connecting portion 22 is the same as that between the first connecting part 31 and the first connecting portion 21.

In, Referring to an embodiment depicted in FIGS. 2 and 6-7, the razor head assembly 10 includes a base 11 and a blade 12, where the blade 12 is detachably connected to the base 11, and the base 11 is connected to the handle assembly 20. In this way, the base 11 is capable of rotating relative to the handle assembly 20 around the axial direction of the locking member 32 to drive the blade 20 to rotate relative to the handle assembly 20 around the axial direction of the locking member 32.

In this embodiment, the blade 12 is detachably connected to the base 11 such that it is convenient to directly replace the blade 12 rather than discarding the whole head assembly 10, which avoids the waste of resources, and leads to enhanced practicality and reduced cost.

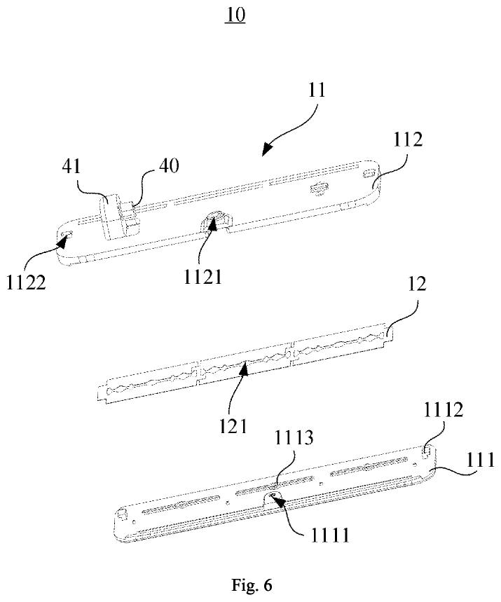

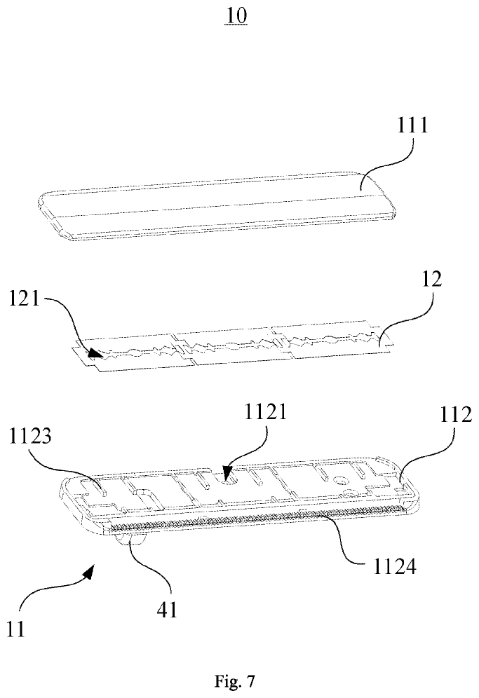

Referring to FIGS. 6-7, the base 11 includes a blade cover 111 and a blade base 112. The blade cover 111 is connected to the blade base 112. The blade 12 is detachably arranged between the blade cover 111 and the blade base 112, and the blade base 112 is connected to the handle assembly 20. Specifically, the blade cover 111 is detachably connected to the blade base 112, and the blade 12 is arranged between the blade cover 111 and the blade base 112, and the blade 12 is detachably connected to the blade cover 111 and the blade base 112.

Referring to an embodiment illustrated in FIGS. 6-7, the razor head assembly 10 further includes a fastener 13. The blade base 112 is provided with a first fastening hole 1121, and the blade cover 111 is provided with a second fastening hole 1111. The fastener 13 can pass through the first fastening hole 1121 and the second fastening hole 1111 in sequence to fixedly connect the blade cover 111 with the blade base 112.

Referring to FIGS. 6-7, the blade cover 111 is engaged with the blade base 112 to enhance the connecting stability between the blade cover 111 and the blade base 112. Specifically, the blade cover 111 is provided with a first clamping part 1112, and the blade base 112 is correspondingly provided with a second clamping part 1122. The first clamping part 1112 is engaged with the second clamping part 1122 to fix the blade cover 111 on the blade base 112. In an embodiment, a plurality of first clamping parts 1112 and a plurality of second clamping parts 1122 are arranged in one-to-one correspondence to enhance the connecting stability between the blade cover 111 and the blade base 112. In an embodiment, the first clamping part 1112 is a buckling element, and the second clamping part 1122 is a buckling hole. In some embodiments, the first clamping part 1112 is a buckling hole, and the second clamping part 1122 is a buckling element.

Referring to FIGS. 6-7, the blade cover 111 is provided with a first limiting part 1113, and the blade 12 is provided with a second limiting part 121. The first limiting part 1113 is matched with the second limiting part 121 to limit and fix the blade 12. In an embodiment, a plurality of first limiting parts 1113 and a plurality of second limiting parts 121 are arranged in one-to-one correspondence to more stably limit and fix the blade 12. In this embodiment, the first limiting part 1113 is a limiting piece, and the second limiting part 121 is a limiting hole, and the limiting piece can pass through the limiting hole to abut against the blade base 112 to limit and fix the blade 12. Specifically, the configuration of the limiting piece is matched with that of the limiting hole. The configuration of the limiting piece can be but is not limited to cuboid shape. In some embodiments, the first limiting part 1113 is a limiting hole, and the second limiting part 121 is a limiting piece.

In this embodiment, referring to FIG. 7, a side of the blade base 112 near the blade 12 is provided with a plurality of supporting components 1123 for supporting the blade 12, facilitating the stable arrangement of the blade 12.

In an embodiment, referring to FIG. 7, a position on the blade base 112 near the tip of the blade 12 is provided with comb teeth 1124 for guiding the blade 12 to cut hair. Specifically, in the moving process of the razor device, the hair first contacts with the comb teeth 1124, and then passes through the comb teeth 1124 to contact with the blade 12 and to be cut by the blade 12. Thus, the arrangement of the comb teeth 1124 can effectively prevent users from directly contacting with the blade 12 to enhance the use safety. Preferably, a position on the blade cover 111 near the tip of the blade 12 is also provided with comb teeth to better guide the blade 12 to razor hair.

In an embodiment, referring to FIGS. 2 and 3, the handle assembly 20 includes a first handle 25 and a second handle 26. One end of the first handle 25 is connected to the razor head assembly 10, and the other end of the first handle 25 is detachably connected to the second handle 26. Specifically, the first connecting portion 21 and the second connecting portion 22 are arranged spaced apart and opposite to each other on an end of the first handle 25 near the razor head assembly 10. In this embodiment, the first handle 25 is curved to facilitate adjusting the angle of the razor head assembly 10 relative to the handle assembly 20.

In an embodiment, referring to FIGS. 2 and 3, an end of the first handle 25 away from the razor head assembly 10 is provided with a first through hole 251, and an end of the second handle 26 near the first handle 25 is provided with a second through hole 261. The handle assembly 20 further includes a fastening part 27, and the fastening piece 27 can pass through the second through hole 261 and the first through hole 251 to achieve the detachable connection between the first handle 25 and the second handle 26.

In this embodiment, the fastening part 27 is elastic, and is arranged in the second handle 26. The fastening part 27 can elastically move into or out of the second through hole 261. The fastening part 27 can be in a locking state or an unlocking state. In the locking state, the fastening part 27 can be elastically moved into the second through hole 261 to be matched with the first through hole 251 to achieve the fixed connection between the first handle 25 and the second handle 26; and in the unlocking state, the fastening part 27 can elastically retract back into the second handle 26 to be separated from the first through hole 251, so that the first handle 25 and the second handle 26 are separated.

In this embodiment, an external force can be applied on the fastening part 27 to drive the fastening part 27 to retract back into the second handle 26 to be departed from the first through hole 251, so as to separate the first handle 25 from the second handle 26. When the first handle 25 and the second handle 26 need to be connected, the external force applied on the fastening part 27 is removed, and the second through hole 261 is aligned with the first through hole 251 such that the fastening part 27 can elastically move into the second through hole 261 to be matched with the first through hole 251 to fixedly connect the first handle 25 to the second handle 26.

In this embodiment, referring to FIGS. 2 and 3, the fastening part 27 includes a convex column 271 and an elastic sheet 272 connected to the convex column 271. The elastic sheet 272 is arranged in the second handle 26 and is configured for supporting the convex column 271. The elastic sheet 272 is capable of elastically stretching or contracting to drive the convex column 271 to move into or out of the second through hole 261. The elastic sheet 272 can be in a locking state or an unlocking state. In the locking state, the elastic sheet 272 can be elastically stretched to move the convex column 271 into the second through hole 261 to match with the first through-hole 251, so as to fixedly connect the first handle 25 to the second handle 26; and in the unlocking state, the elastic sheet 272 can be elastically contracted to move the convex column 271 back into the second handle 26 to be separated from the first through hole 251, so as to separate the first handle 25 from the second handle 26. Specifically, in this embodiment, the convex column 271 and the elastic sheet 272 are integrated.

In this embodiment, referring to FIGS. 2 and 3, the second handle includes a handle bar 262 and a handle tail 263. One end of the handle bar is detachably connected to the handle tail 263, and the other end of the handle bar is detachably connected to the first handle 25. Specifically, the first through hole 251 is arranged at an end of the handle bar 262 near the first handle, and the elastic sheet 272 is arranged in the handle bar 262. In this embodiment, the way in which the handle bar 262 is detachably connected to the handle tail 263 is the same as the way in which the handle bar 262 is detachably connected to the first handle 25. In some embodiments, the way in which the handle bar 262 is detachably connected to the handle tail 263 is different from the way in which the handle bar 262 is detachably connected to the first handle 25.

In this embodiment, a plurality of handle bars 262 are arranged, and can be detachably connected. The handle bar 262 nearest the first handle 25 is detachably connected to the first handle 25, and the handle bar 262 nearest the handle tail 263 is detachably connected to the handle tail 263.

In this embodiment, the number of the handle bars 262 can be adjusted to enable the length of the handle assembly 20 to be adjustable. Users can adjust the number of handle bars 262 on demand, so as to adjust the length of handle assembly 20, effectively improving the use comfort of the razor device.

Referring to FIGS. 2 and 3, an outer side wall of the handle assembly 20 is provided with an anti-skid structure 28. Specifically, in this embodiment, the anti-skid structure 28 is an anti-skid sleeve sheathed on the outer surface of the handle assembly 20. Specifically, the outer surface of the anti-skid sleeve is provided with an anti-skid groove to improve the anti-skid performance of the handle sleeve. More specifically, the handle sleeve is sheathed on the outer surface of the handle tail 263.

In this embodiment, the blade cover 111, the blade base 112 and the handle assembly 20 are all made of an environmental protection material, which can effectively reduce the environmental pollution. In this embodiment, the blade cover 111, the blade base 112 and the handle assembly 20 are all made of a metallic material, which can improve the service life of the razor device. Preferably, the blade cover 111, the blade base 112 and the handle assembly 20 are all made of a zinc alloy material. The zinc alloy material has good antibacterial property and a relatively long service life.

The above-mentioned embodiments are merely illustrative of the disclosure and are not intended to limit the scope of the disclosure. It should be understood that any changes and modifications made by those skilled in the art without departing from the spirit of the disclosure should fall within the scope of the disclosure defined by the appended claims.

What is claimed is:

1. A razor device, comprising:
a razor head assembly;
a handle assembly; and
a locking assembly;
wherein the razor head assembly is connected to the handle assembly, and is configured to be rotatable with respect to the handle assembly for adjusting an angle of the razor head assembly relative to the handle assembly; and
the locking assembly is matched with the razor head assembly and the handle assembly; and the locking assembly is configured to lock the razor head assembly to the handle assembly or unlock the razor head assembly from the handle assembly.

2. The razor device of claim 1, wherein the locking assembly comprises a first connecting part and a locking member; the first connecting part is arranged on the razor head assembly; a first end of the locking member extends into the handle assembly, and is engaged with an inner side wall of the handle assembly; a second end of the locking member extends into the first connecting part to achieve connection between the razor head assembly and the handle assembly; the razor head assembly is rotatable around an axial direction of the locking member in relation to the handle assembly; and the locking member is capable of moving along the axial direction of the locking member relative to the first connecting part and the handle assembly to engage the second end of the locking member with an inner side wall of the first connecting part or disengage the second end of the locking member from the inner side wall of the first connecting part, so as to lock the razor head assembly to the handle assembly or unlock the razor head assembly from the handle assembly.

3. The razor device of claim 2, wherein the handle assembly is provided with a first groove; the first connecting part is provided with a second groove; the locking assembly further comprises a first engagement part, a second engagement part, and a third engagement part; the first engagement part is arranged on an outer side wall of the locking member; the second engagement part is arranged on an inner side wall of the first groove; and the third engagement part is arranged on an inner side wall of the second groove;
the first end of the locking member extends into the first groove, and the first engagement part is engaged with the second engagement part; the second end of the locking member extends into the second groove; and the locking member is capable of moving alone the axial direction of the locking member relative to the first groove and the second groove to engage the first engagement part with the third engagement part or disengage the first engagement part from the third engagement part, so as to lock the razor head assembly to the handle assembly or release the razor head assembly from the handle assembly.

4. The razor device of claim 3, wherein the locking member comprises a locking portion and a pushing portion; the locking portion is connected with the pushing portion; an outer diameter of the locking portion is larger than that of the pushing portion; the first engagement part is arranged on an outer side wall of the locking portion; an end of the locking portion away from the pushing portion extends into the first groove; an end of the locking portion close to the pushing portion extends into the second groove; an end of the pushing portion away from the locking portion extends out of the first connecting part through a bottom wall of the second groove; and the end of the locking portion close to the pushing portion is configured to abut against the bottom wall of the second groove; and
the pushing portion is configured to drive the locking portion to move along an axial direction of the locking portion relative to the first groove and the second groove.

5. The razor device of claim 2, wherein the locking assembly further comprises an elastic component; the elastic component is accommodated in the handle assembly and elastically abuts against the locking member; and the elastic component is configured to provide the locking member with an elastic restoring force to allow the locking member to move close to a side of the first connecting part away from the handle assembly along the axial direction of the locking member.

6. The razor device of claim 1, further comprising:
a rotating shaft;
wherein the razor head assembly is connected to the handle assembly via the rotating shaft; and the razor head assembly is configured to rotate around an axial direction of the rotating shaft relative to the handle assembly.

7. The razor device of claim 1, wherein the razor head assembly comprises a base and a blade; the blade is detachably connected to the base; and the base is connected to the handle assembly.

8. The razor device of claim 7, wherein the base comprises a blade cover and a blade base; the blade cover is connected to the blade base; the blade is detachably arranged between the blade cover and the blade base; and the blade base is connected to the handle assembly.

9. The razor device of claim 1, wherein the handle assembly comprises a first handle and a second handle; one end of the first handle is connected to the razor head assembly; and the other end of the first handle is detachably connected to the second handle.

10. The razor device of claim 9, wherein an end of the first handle away from the razor head assembly is provided with a first through hole; an end of the second handle close to the first handle is provided with a second through hole; the handle assembly further comprises a fastener; and the fastener is configured to pass through the first through hole and the second through hole to detachably connect the first handle with the second handle.
